(19) United States
(12) Patent Application Publication
(10) Pub. No.: US 2025/0075429 A1
(43) Pub. Date: Mar. 6, 2025

(54) PULP FOR GLASS INTERLEAVING PAPER, GLASS INTERLEAVING PAPER, AND PRODUCTION METHOD THEREFOR

(71) Applicant: OJI HOLDINGS CORPORATION, Tokyo (JP)

(72) Inventor: Koichi HAGIHARA, Tokyo (JP)

(21) Appl. No.: 18/727,536

(22) PCT Filed: Jan. 12, 2023
(86) PCT No.: PCT/JP2023/000691

§ 371 Date: Jul. 9, 2024

(30) Foreign Application Priority Data
Jan. 17, 2022 (JP) 2022-004877

(51) Int. Cl. D21H 17/59; D21H 27/10

(52) U.S. Cl. CPC D21H 17/59; D21H 27/10

(57) ABSTRACT

Provided is pulp for glass interleaving paper, and glass interleaving paper, can be produced while foaming is suppressed in a pulp production process and that reduces generation of aggregates composed of a silicone oil. A method of producing such glass interleaving paper is also provided. Also provided is glass interleaving paper wherein contamination of surfaces of glass substrates by aggregates mainly composed of a silicone oil can be reduced. Pulp for glass interleaving paper includes a hydrophilic modified silicone oil and a content ratio of the silicone oil to the pulp is from 0.5 to 2 mg/kg. Additionally, glass interleaving paper includes cellulose pulp as a main component and a hydrophilic modified silicone oil, a basis weight of the glass interleaving paper is from 10 to 100 g/m², and a content ratio of the silicone oil to the glass interleaving paper is from 0.01 to 0.3 mg/kg.

### TECHNICAL FIELD

The present invention relates to pulp for glass interleaving paper, glass interleaving paper, and a production method of the same.

### BACKGROUND ART

Along with diversification of applications of glass substrates, quality requirements for glass interleaving paper have been becoming severer. For example, as for glass substrates for use in flat panel displays such as liquid crystal displays, organic electroluminescent displays, touch panels, and plasma displays, minute electronic components are formed on a surface of the glass substrate and even a slight scratch or contamination on the surface of the glass substrate may cause a defect such as a wire break, resulting in a product defect. Therefore, a high degree of clarity is required for the surfaces of a glass substrate. In particular, extremely high clarity is required for the surfaces of glass substrates for use in liquid crystal displays for TFTs and color filters and organic electroluminescent displays.

In order to enhance a transport efficiency of glass substrates, glass interleaving paper is often used to stack and transport the glass substrates. When the glass substrates are stacked, their weight increases the contact pressure between the glass interleaving paper and the glass substrates, which increases the probability that trace components, foreign substances, and the like in the glass interleaving paper will cause defects in the glass substrates. On the other hand, with high-definition processing on glass substrates, a higher degree of clarity is required for the surfaces of the glass substrates. Under these circumstances, the levels of quality requirements for glass interleaving paper have been becoming higher and higher.

Foreign substances and contaminants generated during a raw pulp production process and foreign substances and contaminants generated during a process of making glass interleaving paper from raw pulp often mix into the glass interleaving paper. The foreign substances and contaminants mixed in the glass interleaving paper are transferred from the glass interleaving paper to (contaminate) the surfaces of the glass substrates in the course of storage or transport, causing defects in the glass substrates.

Glass substrates, especially glass substrates for use in flat panel displays, go through a step of washing the surfaces of the glass substrates using a water-based medium before shipping or before a step of mounting electronic components and the like. In this washing step, most of the foreign substances such as paper dust attached to the surfaces of the glass substrates are washed off but some of the foreign substances and the contaminants may adhere to the surfaces of the glass substrates even after the washing.

Such foreign substances and contaminants include organic, water-insoluble substances derived from a natural resin, a gum substance, an additive, and the like which are liberated from wood, pulp and paper, and the like. Among them, a silicone oil contained in an anti-foaming agent used during pulp production has a strong affinity with glass and generates hydrophobic aggregates on the surface of the glass substrate because the silicone oil is difficult to remove even when the glass substrate is washed with a brush or the like using a washing solution or water. As a result, defects such as wire breaks occur in a step of mounting electronic components and so on.

To address this, for example, Patent Literature 1 discloses use of wood pulp for glass plate interleaving paper in which the silicone content in the wood pulp is 0.5 ppm or less based on the absolute dry mass of the pulp. In addition, Patent Literature 2 discloses wood pulp for glass plate interleaving paper characterized in that a fluorescent X-ray analysis of handmade paper prepared using the wood pulp in accordance with JIS P8222 shows that the number of discontinuous areas with silicon fluorescence X-ray intensity of 1 cps or more is 50/1000 m² or less.

### CITATION LISTS

### Patent Literature

Patent Literature 1: WO2014/104187
Patent Literature 2: JP2016-98468A

### SUMMARY OF INVENTION

### Technical Problem

In Patent Literature 1, in order that the silicone content in the pulp is 0.5 ppm or less, it is necessary to reduce the ratio of the anti-foaming agent added, which may result in insufficient measures against foaming in the pulp production process. In order to obtain the pulp described in Patent Document 2, it is necessary to repeat, in a washing step, solvent washing including washing the pulp with a solvent containing a mixture of toluene and methanol, followed by filtering, which requires a facility capable of treating the solvent to be installed in a normal pulp production line and therefore has drawbacks of being expensive and time-consuming.

The present invention was made in view of the foregoing circumstances. Specifically, an object of the present invention is to provide pulp for glass interleaving paper that can be produced while foaming is suppressed in a pulp production process and that reduces generation of aggregates mainly composed of a silicone oil. Another object of the present invention is to provide a method of producing glass interleaving paper with which the glass interleaving paper can be produced while foaming is suppressed in a pulp production process and which reduces generation of aggregates mainly composed of a silicone oil. Still another object of the present invention is to provide glass interleaving paper with which contamination of surfaces of glass substrates by aggregates mainly composed of a silicone oil can be reduced.

### Solution to Problem

The present inventor conducted a study on anti-foaming agents added to suppress formation of foam in a pulp production process. As a result, the present inventor found that use of a specific type of anti-foaming agent in a specific amount makes it possible to simultaneously achieve both suppression of formation of foam in the pulp production process and reduction of contamination on the surfaces of glass substrates by silicone oil aggregates, and thereby completed the present invention. Specifically, the present invention provides those having the following constituents.

(1) Pulp for glass interleaving paper comprising a hydrophilic modified silicone oil, wherein a content ratio of the hydrophilic modified silicone oil to the pulp is such that a silicone content is from 0.5 to 2 mg/kg.

(2) The pulp for glass interleaving paper according to the (1), wherein the hydrophilic modified silicone oil is contained in a silicone-based anti-foaming agent, and the silicone-based anti-foaming agent is an oil-in-water type silicone-based anti-foaming agent.

(3) A method of producing glass interleaving paper comprising using a silicone-based anti-foaming agent containing a hydrophilic modified silicone oil as an anti-foaming agent in a pulp production process, wherein a ratio of the silicone-based anti-foaming agent added to the pulp is such that a silicone content is from 0.5 to 2 mg/kg.

(4) The method of producing glass interleaving paper according to the (3), wherein the silicone-based anti-foaming agent containing a hydrophilic modified silicone oil is an oil-in-water type silicone-based anti-foaming agent.

(5) Glass interleaving paper comprising: cellulose pulp as a main component; and a hydrophilic modified silicone oil, wherein a basis weight of the glass interleaving paper is from 10 to 100 g/m², and a content ratio of the hydrophilic modified silicone oil to the glass interleaving paper is such that a silicone content ratio is from 0.01 to 0.3 mg/kg.

(6) The glass interleaving paper according to the (5), wherein the hydrophilic modified silicone oil is contained in a silicone-based anti-foaming agent, and the silicone-based anti-foaming agent is an oil-in-water type silicone-based anti-foaming agent.

(7) The glass interleaving paper according to the (5) or (6), wherein a content ratio of talc added as a pitch control agent is less than 0.1% by mass.

### Advantageous Effects of Invention

The pulp for glass interleaving paper of the present invention can be produced with formation of foam suppressed in a pulp production process and can reduce generation of aggregates mainly composed of a silicone oil. A method of producing glass interleaving paper of the present invention achieves the production with formation of foam suppressed in a pulp production process and a reduction in generation of aggregates mainly composed of a silicone oil. Moreover, glass interleaving paper of the present invention is capable of reducing contamination of surfaces of glass substrates by aggregates mainly composed of a silicone oil.

### DESCRIPTION OF EMBODIMENTS

Hereinafter, the present invention will be described in detail. Embodiments described below are merely examples, and the present invention should not be interpreted as being limited to the following embodiments.

The present inventor conducted an analysis of adhering (contaminating) foreign substances that will cause defects in electronic components and the like formed on the surfaces of glass substrates. As a result, the present inventor found that the remaining foreign substances adhering to the surfaces of glass substrates even after a water washing step were aggregates containing a silicone oil, and were sometimes several micrometers or more in size.

In the pulp production process, it is essential to use an anti-foaming agent in a pulp washing step and a pulp bleaching step to reduce a harmful effect of formation of foam. The silicone oil is widely used as an anti-foaming agent in the pulp production process. Therefore, the present inventor studied anti-foaming agents for use in the pulp production process.

Typical anti-foaming agents include mineral oil-based anti-foaming agents and silicone-based anti-foaming agents. The composition of a mineral oil-based anti-foaming agent includes a mineral oil, hydrophobic silica, a silicone oil, a spreading solvent, an emulsifier, water, and so on. The silicone-based anti-foaming agents are of an oil-based emulsion type (W/O type: water-in-oil type) and a self-emulsifying water-based emulsion type (O/W type: oil-in-water type). The composition of both of the types includes a silicone oil, a spreading solvent, an emulsifier, water, and the like. Thus, the anti-foaming agent used in the pulp production process contains a silicone oil irrespective of whether the agent is a mineral oil-based agent or a silicone-based agent.

The silicone oil is a linear polymer containing dimethylsiloxane as main monomer units, which are connected with siloxane bonds. The main chain may partly contain methylphenylsiloxane or methylhydroxysiloxane. Meanwhile, a modified silicone oil is a silicone oil modified by introducing various functional groups into the terminals or side chains (to be described later).

The silicone-based anti-foaming agent has a higher anti-foaming effect than the mineral oil-based anti-foaming agent. For this reason, the amount of the silicone-based anti-foaming agent added can be reduced to from ⅕ to 1/10, as compared to the amount of the mineral oil-based anti-foaming agent added. Therefore, the silicone-based anti-foaming agent is more often used.

The silicone oil has a high affinity with pulp fibers and is usually homogeneously adsorbed on the surfaces of the pulp fibers. In this case, defects such as wire breaks are less likely to occur in the step of mounting electronic components and the like. However, the silicone oil is hydrophobic and insoluble in water, and accordingly exists as an oily substance in water. Therefore, the silicone oil tends to aggregate with hydrophobic substances in water to generate coarse aggregates. When the silicone oil aggregates and becomes coarse to form foreign substances having a size of, for example, several micrometers or more, the aggregates or some silicone oil-based component in the aggregates may be transferred to (contaminate) surfaces of glass substrates, thereby causing defects.

A natural resin (colloidal pitch), a gum substance, and the like liberated in the pulp production process are water-insoluble hydrophobic substances. Then, talc, which is used as a pitch control agent in the pulp production process, is also a hydrophobic substance. The hydrophobic talc generates aggregates by adsorbing the natural resin and the gum substance, which are also hydrophobic. Similarly, the hydrophobic silicone oil generates aggregates by absorbing the natural resin, the gum substance, and the talc.

When a mineral oil-based anti-foaming agent or an oil-based emulsion type (W/O type: water-in-oil type) of silicone-based anti-foaming agent is used among the anti-foaming agents, there is a great concern that the silicone oil contained in the anti-foaming agent, organic water-insoluble substances derived from the natural resin and the gum substance liberated in the pulp production process, and the talc used as the pitch control agent in the pulp production process may be combined to form coarse aggregates.

The silicone-based anti-foaming agents are of the oil-based emulsion type (water-in-oil type: W/O type) and the self-emulsifying water-based emulsion type (O/W type: oil-in-water type) as described above. Of these, the oil-in-water type silicone-based anti-foaming agent has higher water dispersibility.

In recent years, various modified silicone oils have been developed in order to enhance the functionalities of the silicone oils. The modified silicone oil has a structure in which some of the methyl groups of polydimethylsiloxane are replaced with organic functional groups. The modified silicone oils include amino-modified, epoxy-modified, carboxyl-modified, polyether-modified silicone oils, and so on.

For example, in a polyether-modified silicone oil with polyether groups introduced as an organic functional groups, polyethylene glycol, polypropylene glycol, polyethylene glycol-polypropylene glycol copolymers, or the like is added. The solubility of a polyether-modified silicone oil in water and alcohol can be changed by changing the ratio of the organic functional groups and the ratio of ethylene oxide (EO)/propylene oxide (PO) in the polyether-modified silicone oil, so that a hydrophilic (water-soluble) modified silicone oil can be obtained.

Therefore, the present inventor focused on a self-emulsifying water-based emulsion type (O/W type: oil-in-water type) silicone-based anti-foaming agent containing a hydrophilic (water-soluble) modified silicone oil. An example of the hydrophilic (water-soluble) modified silicone oil is the product name “SN Deformer 503K” manufactured by SAN NOPCO LIMITED or the like.

The present inventor found that a self-emulsifying water-based emulsion type (O/W type: oil-in-water type) silicone-based anti-foaming agent containing a hydrophilic (water-soluble) modified silicone oil has low affinity with the hydrophobic natural resin, gum substance, and talc, and is less likely to generate aggregates. As a result, the present inventor found that the above silicone-based anti-foaming agent significantly reduced the generation of coarse aggregates that may cause defects such as wire breaks in the step of mounting electronic components and the like.

The anti-foaming agent used in the pulp production process is an auxiliary agent necessary in wood chip digesting and bleaching steps, but is usually unnecessary in the purified pulp after washing. Therefore, it is desirable that the anti-foaming agent should not remain in the purified pulp. Moreover, it is also desirable that the anti-foaming agent should not remain also in a papermaking process of making glass interleaving paper using the pulp.

Therefore, the present inventor used a silicone-based anti-foaming agent containing a hydrophilic (water-soluble) modified silicone oil in the pulp production process, and found that the anti-foaming agent was easily micronized in water and also easily washed off due to shear force during washing in the pulp production process and the subsequent papermaking process, so that the amount of the anti-foaming agent remaining in glass interleaving paper was significantly reduced as compared to the amount of the anti-foaming agent added to the pulp in the pulp production process.

Moreover, glass substrates, especially glass substrates for use in flat panel displays, go through a step of washing the surfaces of the glass substrates using a water-based medium before shipping or before a step of mounting electronic components and the like. The hydrophilic (water-soluble) modified silicone oil slightly remaining in the glass interleaving paper and transferred to the glass substrates is also washed off and removed in the above washing step.

The present inventor actually produced glass interleaving paper by using various amounts of an oil-in-water type silicone-based anti-foaming agent containing a hydrophilic (water-soluble) modified silicone oil (hereinafter simply referred to as “the hydrophilic (water-soluble) modified silicone oil-containing silicone-based anti-foaming agent”) added in the pulp production process. Moreover, the present inventor conducted a glass substrate transport test using the glass interleaving paper and checked a wire break state of wires formed on the glass substrates.

As a result, when the hydrophilic (water-soluble) modified silicone oil-containing silicone-based anti-foaming agent was added to the pulp in the pulp production process and the content ratio of the hydrophilic (water-soluble) modified silicone oil to the finished pulp after the pulp production was such that the silicone-content ratio was from 0.5 to 2 mg/kg, the production in the pulp production process was achieved with formation of foam suppressed, the generation of aggregates mainly composed of the silicone oil was reduced, and the occurrence of wire breaks was suppressed. The ratio of the hydrophilic (water-soluble) modified silicone oil-containing silicone-based anti-foaming agent added to the pulp is more preferably such that the silicone content ratio is from 0.6 to 1.5 mg/kg.

Here, the silicone content ratio is a numerical value determined as a mass content ratio of dimethylsiloxane units by measuring a ¹H-NMR spectrum of an extract obtained from the pulp or the glass interleaving paper by Soxhlet extraction using hexane (to be described later).

Similarly, regarding the pulp for glass interleaving paper, when the content ratio of the hydrophilic (water-soluble) modified silicone oil to the pulp was such that the silicone content ratio was from 0.5 to 2 mg/kg, the generation of aggregates mainly composed of the silicone oil was reduced and the occurrence of wire breaks was suppressed.

Furthermore, the hydrophilic (water-soluble) modified silicone oil-containing silicone-based anti-foaming agent was added to the pulp for glass interleaving paper, and the content ratio of the hydrophilic (water-soluble) modified silicone oil to the glass interleaving paper obtained when the content ratio of the hydrophilic (water-soluble) modified silicone oil to the finished pulp after the pulp production was such that the silicone content ratio was from 0.5 to 2 mg/kg was measured.

As a result, the glass interleaving paper in which the content ratio of the hydrophilic (water-soluble) modified silicone oil to the pulp for glass interleaving paper was such that the silicone content ratio was from 0.01 to 0.3 mg/kg reduced the generation of aggregates mainly composed of the silicone oil and suppressed the occurrence of wire breaks.

The glass interleaving paper having a silicone content ratio of from 0.01 to 0.3 mg/kg is preferable.

Moreover, the present inventor also studied the upper limit of the content of the talc added as the pitch control agent in the production of pulp or glass interleaving paper. As a result, the present inventor found that the content ratio of the talc to the pulp or glass interleaving paper is preferably less than 0.1% by mass for the purposes of reducing the generation of aggregates of the silicone oil and suppressing the occurrence of wire breaks. The content ratio of the talc to the pulp or glass interleaving paper is more preferably less than 0.01% by mass.

### (Pulp)

The glass interleaving paper contains, as a main component, cellulose pulp having a low content of an adhesive natural resin (pitch) derived from woods. As the cellulose pulp, chemical pulp is preferable and kraft pulp (KP) is preferable. Here, “cellulose pulp is contained as a main component” means that the content of the cellulose pulp exceeds 50% by mass based on the mass of the glass interleaving paper. The content of the cellulose pulp based on the mass of the glass interleaving paper is preferably 70% by mass or more and more preferably 90% by mass or more. Examples of the chemical pulp other than the kraft pulp include sulfite pulp (SP), soda pulp (AP), and so on.

The pulp freeness is preferably from 200 to 700 mlcsf. Here, the freeness is a Canadian standard freeness in accordance with JIS P8121. When the pulp freeness is controlled within a range of from 200 to 700 mlcsf, the glass interleaving paper can be made to have the mechanical strength and processability necessary for glass interleaving paper. When the pulp freeness is less than 200 mlcsf, the glass interleaving paper tends to have a high density and low cushioning properties, and has a risk of easily scratching the surfaces of glass substrates. On the other hand, when the pulp freeness is more than 700 mlcsf, the glass interleaving paper has a low paper strength and has a risk of tearing during a distribution process or a production process. The pulp freeness is more preferably from 350 to 600 mlcsf. As a method of beating pulp, a known method can be used.

Regarding papermaking chemicals for use in making glass interleaving paper, various known chemicals can be used as long as they will not contaminate the glass surfaces. Examples of the papermaking chemicals include paper strength enhancers such as polyacrylamide, water resistant agents such as polyamide polyamine epichlorohydrin, softeners, antistatic agents, defoamers, slime control agents, fillers, dyes, and so on. Since all of these papermaking chemicals have a risk of contaminating glass substrates, the total content of the chemicals, even if added, is preferably 0.1% by mass or less.

### (Glass Interleaving Paper Production Method)

A glass interleaving paper production method is not particularly limited. The glass interleaving paper can be made by using any of various paper machines and selecting appropriate paper making conditions. As the paper machine, there are a Fourdrinier former, a twin wire former, a cylinder former, an inclined former, and so on. A layer structure of the glass interleaving paper may have a single layer or multiple layers.

### (Glass Interleaving Paper)

As for a basis weight of the glass interleaving paper, a small basis weight is preferable because the mass of the paper during transport is small, but if it is too small, a shock absorbing function sufficient for glass substrates cannot be imparted to the glass interleaving paper. On the other hand, a large basis weight of the glass interleaving paper at some level is preferable from the viewpoint of the shock absorbing function, but if it is too large, the mass of the paper during transport is large, which is undesirable. In view of the balance between the shock absorbing function and the mass, the basis weight of the glass interleaving paper is from 10 to 100 g/m². The basis weight of the glass interleaving paper is more preferably from 30 to 80 g/m².

The thickness of the glass interleaving paper is preferably from 25 to 250 μm from the viewpoints of the shock absorbing performance and workability. The density of the glass interleaving paper is preferably from 0.4 to 1.2 g/cm³.

The glass interleaving paper in the present embodiment is suitable for use for protecting multiple glass substrates for flat panel displays such as liquid crystal displays, organic electroluminescent displays, touch panels, and plasma displays when the glass substrates in a stacked state are stored and transported. Among them, the glass interleaving paper is used suitably for liquid crystal displays (for TFTs and color filters) and organic electroluminescence displays, for which a high degree of clarity is required.

### EXAMPLES

Hereinafter, the present invention will be described in detail by using Examples, but the present invention should not be limited to these Examples. Here, the numeric value specifying a content is a mass-based numeric value (% by mass) of a solid content or active component. Unless otherwise specified, made paper was treated in accordance with JIS P8111 and then was subjected to measurements and evaluation tests.

### <Silicone Content Ratio in Pulp or Glass Interleaving Paper>

The pulp was cut into approximately 1 cm squares. In addition, the glass interleaving paper was cut into approximately 1 cm squares. Soxhlet extraction was performed for about 3.5 hours using hexane as a solvent to extract components from the pulp or the glass interleaving paper. The obtained extraction liquid was concentrated to dryness by using a rotary evaporator, and the resultant was re-dissolved in 1 mL of deuterated chloroform to prepare a measurement sample. As a measurement instrument, a nuclear magnetic resonance apparatus (model AVANCE500 manufactured by Bruker BioSpin K.K.) was used to measure a ¹H-NMR spectrum and quantify dimethylsiloxane units. For this quantification, a calibration curve was created by using a deuterated chloroform solution of polydimethylsiloxane as a standard, and the quantification was performed using a multi-point calibration curve method.

### <Talc Content Ratio in Pulp or Glass Interleaving Paper>

The pulp or glass interleaving paper was ashed in accordance with JIS P8251. Next, the talc content ratio (% by mass) in the obtained ash was obtained by using a fluorescence X-ray diffraction apparatus (RINT-UltimaIII manufactured by Rigaku Corporation) based on a calibration curve created in advance by using glass interleaving paper containing a predetermined amount of talc. The talc content ratio m in the glass interleaving paper was obtained in accordance with the following formula (1):

$$m = ( b / a ) \times c \times 100 , \qquad ( 1 )$$

where m: Talc content ratio (% by mass),
a: Mass of glass interleaving paper (g),
b: Mass of ash (g), and
c: Talc content ratio in ash (% by mass).

### <Glass Plate Transport Test>

Foamed urethane was laid on a glass mounting surface of an L-shaped aluminum rack with an angle of 75 degrees, and 120 glass plates with a size of 680 mm×880 mm×0.7 mm were placed on the mounting surface for vertically mounting the glass plates and leaned on a backrest surface extending vertically from the rear end of the mounting surface so that the glass plates were stacked with glass interleaving paper inserted between the glass plates and were in parallel with the backrest surface. A band-shaped belt fixed to the rack was stretched from the rear end around the entire periphery of the backrest surface to fix the glass plates. The entire surfaces of the rack set as described above were covered with a packaging material to prevent dirt, dust, and the like from entering from the outside. After that, a transport test was performed on a truck at a transport distance of 1100 km (the rack was stored for 5 days in an environment at 40° C. and 95% RH during the transport).

### <Performance Evaluation>

On the surfaces of the 120 glass plates after the transport test, straight wires with a width of 5 μm were formed at intervals of 80 μm using an existing method. Next, wire break states of the formed wires were observed. The performance evaluation was conducted as follows.
∘: No wire break was found on all the glass plates.
x: Wire breaks were found on multiple glass plates.

### Example 1

A commercially available NBKP (nadelholz bleached kraft pulp) A, to which talc is not added, was used as the raw material pulp. In the pulp washing step and bleaching step in the pulp production process, an oil-in-water type (O/W type) silicone-based anti-foaming agent containing a hydrophilic (water-soluble) modified silicone oil as a main component was used. A pulp slurry having a freeness of 450 mlcsf was prepared and pulp having a silicone content ratio of 1.3 mg/kg and a talc content ratio of 0% by mass was obtained. After that, using this pulp, paper was made by using a Fourdrinier paper machine without adding any papermaking chemicals. After the paper making, the paper was dried to obtain glass interleaving paper having a basis weight of 50 g/m², a silicone content ratio of 0.2 mg/kg, and a talc content ratio of 0% by mass.

### Example 2

A commercially available NBKP (nadelholz bleached kraft pulp) B, to which talc is not added, was used as the raw material pulp. In the pulp washing step and bleaching step in the pulp production process, an oil-in-water type (O/W type) silicone-based anti-foaming agent containing a hydrophilic (water-soluble) modified silicone oil as a main component was used. A pulp slurry having a freeness of 450 mlcsf was prepared and pulp having a silicone content ratio of 0.7 mg/kg and a talc content ratio of 0% by mass was obtained. After that, glass interleaving paper having a basis weight of 50 g/m², a silicone content ratio of 0.1 mg/kg, and a talc content ratio of 0% by mass was obtained under the same conditions as in Example 1 except for the above-specified ones.

### Comparative Example 1

A commercially available NBKP (nadelholz bleached kraft pulp) C, to which talc is not added, was used as the raw material pulp. In the pulp washing step and bleaching step in the pulp production process, a water-in-oil type (W/O type) silicone-based anti-foaming agent containing an unmodified silicone oil as a main component was used. A pulp slurry having a freeness of 450 mlcsf was prepared and pulp having a silicone content ratio of 1.1 mg/kg and a talc content ratio of 0% by mass was obtained. After that, glass interleaving paper having a basis weight of 50 g/m², a silicone content ratio of 0.8 mg/kg, and a talc content ratio of 0% by mass was obtained under the same conditions as in Example 1 except for the above-specified ones.

### Comparative Example 2

A commercially available NBKP (nadelholz bleached kraft pulp) D, to which talc is added, was used as the raw material pulp. In the pulp washing step and bleaching step in the pulp production process, a water-in-oil type (W/O type) silicone-based anti-foaming agent containing an unmodified silicone oil as a main component was used. A pulp slurry having a freeness of 450 mlcsf was prepared and pulp having a silicone content ratio of 1.2 mg/kg and a talc content ratio of 0.7% by mass was obtained. After that, glass interleaving paper having a basis weight of 50 g/m², a silicone content ratio of 0.9 mg/kg, and a talc content ratio of 0.3% by mass was obtained under the same conditions as in Example 1 except for the above-specified ones.

### Comparative Example 3

A commercially available NBKP (nadelholz bleached kraft pulp) E, to which talc is not added, was used as the raw material pulp. In the pulp washing step and bleaching step in the pulp production process, a non-emulsion type mineral oil-based anti-foaming agent was used. A pulp slurry having a freeness of 450 mlcsf was prepared and pulp having a silicone content ratio of 3.5 mg/kg and a talc content ratio of 0.7% by mass was obtained. After that, glass interleaving paper having a basis weight of 50 g/m², a silicone content ratio of 1.8 mg/kg, and a talc content ratio of 0% by mass was obtained under the same conditions as in Example 1 except for the above-specified ones.

TABLE 1

| | | | | | Glass Interleaving | | |
|---|---|---|---|---|---|---|---|
| | | | Pulp | | Paper | | |
| | | | Silicone | Talc | Silicone | Talc | |
| | Anti-Foaming Agent Used | | Content | Content | Content | Content | |
| | In Pulp Production Process | | Ratio | Ratio | Ratio | Ratio | Wire |
| | Base | Type | (Mg/Kg) | (% By Mass) | (Mg/Kg) | (% By Mass) | Break |
| Example 1 | Hydrophilic | Oil-In-Water Type | 1.3 | 0 | 0.2 | 0 | ∘ |
| | (Water-Soluble) | | | | | | |
| | Modified Silicone | | | | | | |
| Example 2 | Hydrophilic | Oil-In-Water Type | 0.7 | 0 | 0.1 | 0 | ∘ |
| | (Water-Soluble) | | | | | | |
| | Modified Silicone | | | | | | |
| Comparative | Unmodified | Water-In-Oil Type | 1.1 | 0 | 0.8 | 0 | x |
| Example 1 | Silicone | | | | | | |
| Comparative | Unmodified | Water-In-Oil Type | 1.2 | 0.7 | 0.9 | 0.3 | x |
| Example 2 | Silicone | | | | | | |
| Comparative | Mineral Oil | Non Emersion Type | 3.5 | 0 | 1.8 | 0 | x |
| Example 3 | | | | | | | |

Table 1 presents evaluation results of Examples 1 and 2 and Comparative Examples 1 to 3. As a result, no wire break was observed in the wires on all the glass plates stacked by using the glass interleaving paper in Examples 1 and 2. In contrast, among the glass plates stacked by using the glass interleaving paper in Comparative Examples 1 to 3, multiple glass plates were observed as having wire breaks in the wires. From the above results, it was clarified that the glass interleaving paper of the present invention has an effect of suppressing defects such as wire breaks due to contamination.

1. Pulp for glass interleaving paper comprising a hydrophilic modified silicone oil,
wherein a content ratio of the hydrophilic modified silicone oil to the pulp is such that a silicone content is from 0.5 to 2 mg/kg.

2. The pulp for glass interleaving paper according to claim 1, wherein the hydrophilic modified silicone oil is contained in a silicone-based anti-foaming agent, and
wherein the silicone-based anti-foaming agent is an oil-in-water type silicone-based anti-foaming agent.

3. A method of producing glass interleaving paper, the method comprising using as an anti-foaming agent a silicone-based anti-foaming agent containing a hydrophilic modified silicone oil in a pulp production process,
wherein a ratio of the silicone-based anti-foaming agent added to pulp is such that a silicone content is from 0.5 to 2 mg/kg.

4. The method of producing glass interleaving paper according to claim 3,
wherein the silicone-based anti-foaming agent containing a hydrophilic modified silicone oil is an oil-in-water type silicone-based anti-foaming agent.

5. Glass interleaving paper comprising:
cellulose pulp as a main component; and
a hydrophilic modified silicone oil,
wherein a basis weight of the glass interleaving paper is from 10 to 100 g/m², and
wherein a content ratio of the hydrophilic modified silicone oil to the glass interleaving paper is such that a silicone content ratio is from 0.01 to 0.3 mg/kg.

6. The glass interleaving paper according to claim 5, wherein the hydrophilic modified silicone oil is contained in a silicone-based anti-foaming agent, and
wherein the silicone-based anti-foaming agent is an oil-in-water type silicone-based anti-foaming agent.

7. The glass interleaving paper according to claim 5, wherein a content ratio of talc added as a pitch control agent is less than 0.1% by mass.

8. The glass interleaving paper according to claim 6, wherein a content ratio of talc added as a pitch control agent is less than 0.1% by mass.
